(19) United States
(12) Patent Application Publication
(10) Pub. No.: US 2026/0104495 A1
(43) Pub. Date: Apr. 16, 2026

(54) METHOD AND APPARATUS FOR CALIBRATING INTERNAL ERROR OF OVAL SCANNING AIRBORNE BATHYMETRIC LIDAR STEP BY STEP

(71) Applicant: Guilin University of Technology, Guilin (CN)

(72) Inventors: Guoqing Zhou, Guilin (CN); Gang Liang, Guilin (CN); Guofu Qin, Guilin (CN)

(21) Appl. No.: 19/276,246

(22) Filed: Jul. 22, 2025

(30) Foreign Application Priority Data
Oct. 10, 2024 (CN) 202411404202.2

(51) Int. Cl. G01S 7/497; G01S 7/48; G01S 7/481; G01S 17/00; G01S 17/89

(52) U.S. Cl. CPC G01S 7/497; G01S 7/4808; G01S 7/4813; G01S 7/4817; G01S 17/006; G01S 17/89

(57) ABSTRACT

A method and apparatus for calibrating an internal error of an oval scanning airborne bathymetric lidar step by step are provided. By calibrating a laser ranging error, a collimation axis error and a rotation angle error of a driving motor step by step, the complexity of error calibration is reduced, the influence of multi-factor interference on overall calibration accuracy is avoided, and an internal error value of a lidar can be effectively calibrated. The error value can be used to assess quality of an instrument in the stage of instrument processing and assembly, and to correct a system error in a subsequent calculation to avoid the decline of accuracy caused by the error of own measurement data of the lidar, thereby improving acquisition accuracy of laser three-dimensional point cloud data.

### CROSS-REFERENCE TO RELATED APPLICATION

This patent application claims the benefit and priority of Chinese Patent Application No. 202411404202.2 filed with the China National Intellectual Property Administration on Oct. 10, 2024, the disclosure of which is incorporated by reference herein in its entirety as part of the present application.

### TECHNICAL FIELD

The present disclosure belongs to the technical field of airborne laser bathymetry, and in particular to a method and apparatus for calibrating an internal error of an oval scanning airborne bathymetric lidar step by step.

### BACKGROUND

Airborne laser bathymetry is an advanced shallow water measurement technology which integrates a laser scanning system, a global navigation satellite system and an inertial navigation system. By emitting blue-green band laser pulses and receiving echo signals, this technology enables full three-dimensional coverage and high-resolution measurement across both marine and terrestrial environments, with advantages of high efficiency, flexibility, cost-effectiveness, and operational safety. Compared with a traditional ship-borne sonar measurement method, the airborne laser bathymetry technology is not limited by terrain, with high measurement efficiency and dense measurement points, which is the most effective means for high-efficiency bathymetry at present, and has a wide application and development prospect.

A core objective of an airborne bathymetric lidar is to accurately obtain three-dimensional coordinates of the laser footprints. Airborne bathymetry lidar, as a highly integrated and complex system, is affected by various systematic errors and random errors in measurement accuracy. To obtain high-precision laser three-dimensional point cloud data, it is necessary to calibrate the airborne bathymetric lidar to eliminate the measurement error and improve the measurement accuracy. The errors influencing the measurement accuracy include an integrated error and an internal error. The integrated error of the system is mainly a boresight misalignment error, i.e., an error caused by a non-parallelism between the coordinate axes of a laser scanning system and an inertial platform, which is usually corrected by flight dynamic calibration. Internal error refers to an error existing in the laser scanning system itself, mainly including a ranging error and a structural error, which cannot be eliminated by flight dynamic calibration, and must be calibrated before flight. Calibrating the internal error of airborne bathymetric lidar not only can assess the quality of device in the stages of instrument processing and assembly, but also can correct the systematic error in the subsequent calculation, thereby avoiding the error of the measurement data of the lidar itself and improving the measurement accuracy to the greatest extent.

In literature “Research on Self-calibration Method of Domestic Spiral Scanning Laser Radar System” (Yang Shujuan et al., 2018, Journal of Electronics & Information Technology) and “Calibration of Laser Scanning Measurement System for Mini UAV” (Tian Lvlin et al., 2024, Journal of Information Engineering University), book “Theory and method of airborne lidar measurement technology” (Zhang Xiaohong, 2007, Wuhan University Press) and invention patents “Geometric Correction Method and Device for Boresight Misalignment Error of Unmanned Aerial Vehicle-borne Radar” (CN114859326A, 2022) and “Boresight Misalignment Error Correction Method Based on Airborne Laser Bathymetry System” (CN116299369A, 2023), a system boresight misalignment error of the airborne lidar is calibrated, but the internal error is not calibrated. In literature “The Calibration Model and Simulation Analysis of Circular Scanning Airborne Laser Bathymetry System” (Shen Erhua et al., 2016, Acta Geodaetica et Cartographica Sinica), “Research of Error Analysis and Positioning Accuracy of Airborne Dual-Frequency LiDAR” (La Deliang et al., 2018, Laser & Optoelectronics Progress), “Effect Analysis of Positioning Model and Boresight Error Analysis of Airborne Lidar Bathymetry System” (Yu Jiayong et al., 2019, Infrared and Laser Engineering) and the book “Theory and Methods of Error Processing for Airborne LiDAR Data” (Wang Liying, 2013, Surveying and Mapping Press), although the influence of internal errors on measurement accuracy has been analyzed through simulation, the analysis mainly focuses on the calibration of the systematic boresight misalignment errors, and a calibration scheme for internal errors is not provided. In invention patent “Coordinate System Error Correction Method of Scanning Platform Based on Airborne Lidar System” (CN116990787A, 2023), the scanning coordinates are corrected through a correction equation, which corrects and compensates an overall influence caused by structural errors, but does not clearly calibrate the internal error values. In invention patents “Calibration Method for Ranging Accuracy of Airborne Lidar Based on Circular Scanning” (CN111123245A, 2020) and “Calibration Method for Maximum Ranging Ability and Angular Accuracy of Airborne Lidar Based on Circular Scanning” (CN111123246A, 2020), a ranging error value and an angular error value are respectively calibrated, but these methods are oriented to a circular scanning airborne lidar, and not suitable for an oval scanning airborne lidar.

In conclusion, in currently disclosed patent literatures on airborne lidar calibration, most studies focus on calibrating systematic boresight misalignment errors, while few involves the calibration of internal errors of the lidar. Particularly, no effective solutions have been proposed for calibrating internal error values of the oval scanning airborne lidar.

### SUMMARY

An objective of the present disclosure is to provide a method and apparatus for calibrating an internal error of an oval scanning airborne bathymetric lidar step by step for the disadvantages in the prior art, thereby solving a calibration problem of an internal error value of the oval scanning airborne bathymetric lidar.

To achieve the objective described above, according to a first aspect of the present disclosure, the present disclosure provides a method for calibrating an internal error of an oval scanning airborne bathymetric lidar step by step, including:
installing an airborne bathymetric lidar on a tripod, and turning on a transceiver and a rotating mirror scanning apparatus of the lidar to irradiate a complete laser scanning trajectory on a flat wall surface;
installing a prism-free total station on the tripod and leveling the prism-free total station;
calibrating a laser ranging error;
calibrating a collimation axis error; and
calibrating a rotation angle error of a driving motor;

In the method for calibrating the internal error of the oval scanning airborne bathymetric lidar step by step, calibrating the laser ranging error includes:
marking a center point of a lidar mirror as P, a center point, vertexes of a long axis and vertexes of a short axis of the laser scanning trajectory as O, A, C, B and D respectively with a scanning sequence of laser footprints as: A-B-C-D, and a center point of the prism-free total station as G;
turning off the transceiver and the rotating mirror scanning apparatus of the lidar, manually rotating the lidar mirror, turning on the transceiver every 30°, collecting waveform data and performing waveform detection to obtain a calculated distance value, and measuring an observed distance value from the center of the lidar mirror to a laser footprint of the wall surface by the prism-free total station;
enabling the calculated distance value s to be [s₁, s₂, . . . , s₁₂]^{T}, and a corresponding observed distance value S′ thereof to be [S₁′, S₂′, . . . , S₁₂′]^{T}.

a calculation formula of the calculated distance value is as follows:

$$s = c Δ t / 2 ;$$

where c is a propagation speed of laser in air, and Δt is propagation time of laser in the air obtained by the waveform detection;
adding an error plus constant K to the above formula:

$$S = f ( K ) = s + K = {[ {S}_{1} , {S}_{2} , … , {S}_{12} ]}^{T}$$

where an initial value of the error plus constant K is set as a negative value of a design length of an internal optical path of the lidar;
linearizing the above formula to establish an error equation:

$$v = \frac{\partial f}{\partial K} Δ K - [ {S}^{′} - S ] = Δ K - [ {S}^{′} - S ] ;$$

writing the above formula in a matrix form:

$$V = BX - L ;$$

$$where X = Δ K ;$$

providing a total of 12 laser footprints, then

$$B = [ \begin{matrix}1 & 0 & … & 0 \\ 0 & 1 & … & 0 \\ … & … & 1 & … \\ 0 & 0 & … & 1\end{matrix} ] , L = [ \begin{matrix}{L}_{1} \\ {L}_{2} \\ ⋮ \\ {L}_{i} \\ ⋮ \\ {L}_{12}\end{matrix} ] ;$$

for each laser footprint,

$${L}_{i} = [ {S}_{i}^{′} - {S}_{i} ] ;$$

based on a principle of least-squares indirect adjustment, listing a normal equation of the error equation:

$${B}^{T} BX = {B}^{T} L ;$$

solving the above formula to obtain:

$$X = {( {B}^{T} B )}^{- 1} {B}^{T} L ;$$

substituting S and S′ into the above formula to calculate correction ΔK of K;
updating the error plus constant according to ΔK:

$$K + Δ K \to K ;$$

recalculating S according to an updated error plus constant K, then recalculating L, and then solving the normal equation of the error equation based on the principle of least-squares indirect adjustment to obtain the correction ΔK, and updating an error plus constant K again, repeating the steps until |ΔK|<0.001;
in consideration of an error, the calculated distance value of the lidar is as follows:

$$S = c Δ t / 2 + K .$$

In the method for calibrating the internal error of the oval scanning airborne bathymetric lidar step by step, calibrating the collimation axis error includes:
the collimation axis error includes an error of an included angle between a mirror normal and a rotating shaft of the driving motor and an error of an included angle between an incident light and the rotating shaft of the driving motor;
establishing a laser scanning reference coordinate system O-XYZ with a center of the lidar mirror as an origin, with an X axis as an opposite direction of the incident light, a Y axis as a flight direction, and a Z axis and the X axis and Y axis forming a right-handed system; defining the rotation angle of the driving motor as θ, the included angle between the mirror normal and the rotating shaft of the driving motor as α, the included angle between the incident light and the rotating shaft of the driving motor as β, and a direction vector of the mirror normal in the O-XYZ coordinate system as follows:

$$\vec{F} = [ \begin{matrix}{F}_{x} \\ {F}_{y} \\ {F}_{z}\end{matrix} ] = [ \begin{matrix}sin ( α ) cos ( β ) cos ( θ ) + cos ( α ) sin ( β ) \\ sin ( α ) sin ( θ ) \\ sin ( α ) sin ( β ) cos ( θ ) - cos ( α ) cos ( β )\end{matrix} ] ;$$

obtaining included angles between projections of reflected light on an XZ plane and a YZ plane and the Z axis from the above formula as follows:

$${φ}_{x} ( α , β , θ ) = 2 {tan}^{- 1} ( {F}_{x} / \vert {F}_{z} \vert ) - 90 ° ;$$

$${φ}_{y} ( α , β , θ ) = {tan}^{- 1} ( {F}_{y} / \vert {F}_{z} \vert ) ;$$

defining an included angle between the reflected light and a vertical downward direction as a scanning angle, and calculating the scanning angle φ according to the above formula:

$$φ ( α , β , θ ) = {tan}^{- 1} ( \sqrt{{( tan {φ}_{x} )}^{2} + {( tan {φ}_{y} )}^{2}} ) ;$$

defining an included angle between a connecting line of the laser footprint and a center point of the laser scanning trajectory and a positive direction of the X axis as an azimuth angle, when the connecting line of the center of the laser scanning trajectory and the center of the lidar mirror is perpendicular to a target plane, calculating the azimuth angle Ψ according to the included angles between the projections of reflected light on the XZ and YZ planes and the Z axis:

$$Ψ ( α , 45 ° , θ ) = \{ \begin{matrix}{tan}^{- 1} ( tan {φ}_{y} / tan {φ}_{x} ) , 0 ° \leq θ < 90 ° \\ {tan}^{- 1} ( tan {φ}_{y} / tan {φ}_{x} ) + 90 ° , 90 ° \leq θ \leq 270 ° \\ {tan}^{- 1} ( tan {φ}_{y} / tan {φ}_{x} ) + 180 ° , 270 ° < θ \leq 360 °\end{matrix} ; \qquad ( 1 )$$

calculating coordinates of the laser footprint in the laser scanning reference coordinate system according to the calculated distance value S of the lidar, the projections φₓ and φ_{y} of the reflected light on the XZ and the YZ planes and the scanning angle φ:

$$[ \begin{matrix}x ( α , β , θ ) \\ y ( α , β , θ ) \\ z ( α , β , θ )\end{matrix} ] = [ \begin{matrix}S * cos φ * tan {φ}_{x} \\ S * cos φ * tan {φ}_{y} \\ - S * cos φ\end{matrix} ] ;$$

turning off the transceiver and the rotating mirror scanning apparatus of the lidar, and manually rotating the lidar mirror to enable laser footprints to fall to points A, B, C and D in turn, turning on the transceiver to collect waveform data, eliminating the laser ranging error after waveform detection to obtain calculated distance values S_{A}, S_{B}, S_{C} and S_{D} in turn, and substituting the calculated distance values as well as rotation angles of the driving motor which are 0°, 90°, 180° and 270° into the above formula in turn to obtain coordinates of the points A, B, C and D in the laser scanning reference coordinate system as follows: [x_{A}(α, β, 0°), y_{A}(α, β, 0°), z_{A}(α, β, 0°)]^{T}, [x_{B}(α, β, 90°), y_{B}(α, β, 90°), z_{B}(α, β, 90°)]^{T}, [x_{C}(α, β, 180°), y_{C}(α, β, 180°), z_{C}(α, β, 180°)]^{T}, and [x_{D}(α, β, 270°), y_{D}(α, β, 270°), z_{D}(α, β, 270°)]^{T};
where a formula for calculating a distance between two points according to the coordinates of two points is as follows:

$$H ( α , β ) = \sqrt{{( {x}_{1} - {x}_{2} )}^{2} + {( {y}_{1} - {y}_{2} )}^{2} + {( {z}_{1} - {z}_{2} )}^{2}} ;$$

wherein initial values of α and β are set as the designed included angle between the mirror normal and the rotating shaft of the driving motor and the designed included angle between the incident light and the rotating shaft of the driving motor, respectively;
substituting the coordinates of points A and B, points A and C, points A and D, points B and C, points B and D, and points C and D into the above formula in turn to obtain an AB distance H_{AB}, an AC distance H_{AC}, an AD distance H_{AD}, a BC distance H_{BC}, a BD distance H_{BD} and a CD distance H_{CD}, respectively;
measuring an AB distance H′_{AB}, an AC distance H′_{AC}, an AD distance H′_{AD}, a BC distance H′_{BC}, a BD distance H′_{BD}, and a CD distance H′_{CD} by the prism-free total station;

$$enabling H = \{ {H}_{A B} , {H}_{A C} , {H}_{A D} , {H}_{B C} , {H}_{B D} , {H}_{CD} \} , and {H}^{′} = \{ {H}_{AB}^{′} , {H}_{A C}^{′} , {H}_{AD}^{′} , {H}_{BC}^{′} , {H}_{BD}^{′} , {H}_{CD}^{′} \} ;$$

linearizing a distance calculation formula to establish an error equation:

$$v = [ \frac{\partial H}{\partial α} Δ α + \frac{\partial H}{\partial β} Δ β ] - [ {H}^{′} - H ] ;$$

writing the above formula in a matrix form:

$$V = B X - L ; where X = {[ Δ α Δ β ]}^{T} ;$$

providing a total of 6 laser footprints, then

$$B = [ \begin{matrix}{B}_{1} & 0 & ⋯ & 0 \\ 0 & {B}_{2} & ⋯ & 0 \\ ⋮ & ⋮ & {B}_{i} & ⋮ \\ 0 & 0 & ⋯ & {B}_{6}\end{matrix} ] , L = [ \begin{matrix}{L}_{1} \\ {L}_{2} \\ ⋮ \\ {L}_{i} \\ ⋮ \\ {L}_{6}\end{matrix} ] ;$$

for each laser footprint,

$${B}_{i} = [ \frac{\partial {H}_{i}}{\partial α} \frac{\partial {H}_{i}}{\partial β} ] , {L}_{i} = [ {{H}_{i}}^{′} - {H}_{i} ] ;$$

based on the principle of least-squares indirect adjustment, listing a normal equation of the error equation:

$${B}^{T} B X = {B}^{T} L ;$$

solving the above formula to obtain:

$$X = {( {B}^{T} B )}^{- 1} {B}^{T} L ;$$

substituting H and H′ into the above formula to calculate corrections Δα and Δβ of α and β;
updating the included angle between the mirror normal and the rotating shaft of the driving motor and the included angle between the incident light and the rotating shaft of the driving motor according to Δα and Δβ:

$$α + Δ α \to α ;$$

$$β + Δβ \to β ;$$

recalculating H according to an updated included angle α between the mirror normal and the rotating shaft of the driving motor and an updated included angle β between the incident light and the rotating shaft of the driving motor after update, then recalculating B and L, and then solving the normal equation of the error equation based on the principle of least-squares indirect adjustment to obtain the corrections Δα and Δβ for updating α and β again, repeating the steps until |Δα|<0.001 and |Δβ|<0.001;
calculating an error value of the included angle between the mirror normal and the rotating shaft of the driving motor according to a design value and a measured value:

$$Δ α = α - 5 ° ;$$

where α is a finally calculated included angle between the mirror normal and the rotating shaft of the driving motor; and
calculating an error value of the included angle between the incident light and the rotating shaft of the driving motor according to a design value and a measured value:

$$Δ β = β - 45 ° ;$$

where β is a finally calculated included angle between the incident light and the rotating shaft of the driving motor.

In the method for calibrating the internal error of the oval scanning airborne bathymetric lidar step by step, calibrating the rotation angle error of the driving motor includes:
adjusting a position of the lidar to enable a connecting line OP of the center of the laser scanning trajectory and the center of the lidar mirror to be perpendicular to the wall surface, where calibrating the rotation angle error of the driving motor is as follows:
turning off the rotating mirror scanning apparatus of the lidar, turning on the transceiver, wherein the driving motor is at a zero position, and marking reflected laser as E at the laser footprint on the wall surface;
measuring an included angle ∠AOE between OA and OE by the prism-free total station;
when point E is counterclockwise at point A, an azimuth angle is Ψ=∠AOE, and when the point E is clockwise at the point A, the azimuth angle is Ψ=360°−∠AOE;
according to an azimuth angle calculation formula, in a case of knowing the included angle α between the mirror normal and the rotating shaft of the driving motor, expressing the azimuth angle calculation formula as follow:

$$Ψ = P ( θ ) ;$$

wherein P(θ) is obtained by substituting the calculated parameter α into formula (1), substituting the measured azimuth angle Ψ into the above formula to solve an actual rotation angle θ of the driving motor when the laser footprint falls to the point E, wherein when the point E is counterclockwise at the point A, an error value of the rotation angle of the driving motor is Δθ=θ, when the point E is clockwise at the point A, the error value of the rotation angle of the driving motor is Δθ=θ−360°;
repeating above steps for five times to acquire five groups of the error values of the rotation angle of the driving motor, and averaging the five groups of error values to obtain the error value Δθ of the rotation angle of the driving motor:

$$Δ θ = \frac{{\sum }_{i = 1}^{5} Δ {θ}_{i}}{5} ;$$

where Δθᵢ is an error value of the rotation angle of the driving motor obtained in an i^{-th} measurement;
in consideration of an error, an actual rotation angle of the driving motor is as follows:

$$\hat{θ} = θ + Δ θ ;$$

where θ is a rotation angle of the driving motor measured by an angle encoder of the lidar, \hat{θ} is a rotation angle of the driving motor after error correction, when \hat{θ}>360°, \hat{θ}=θ−360°, and when \hat{θ}<0°, \hat{θ}=\hat{θ}+360°.

The present disclosure further provides an apparatus for calibrating an internal error of an oval scanning airborne bathymetric lidar step by step, including:
a first deployment module, configured to deploy an airborne bathymetric lidar and a prism-free total station in a calibration field;
a first acquisition module, configured to acquire a distance calculation value of a laser footprint on a wall surface based on the lidar;
a second acquisition module, configured to acquire a distance observation value between two points and included angles formed by connecting lines among three points based on the prism-free total station;
a first calculation module, configured to calculate a laser ranging error;
a second calculation module, configured to calculate a collimation axis error; and
a third calculation module, configured to calculate a rotation angle error of a driving motor.

The present disclosure has the following beneficial effects:

The error calibration method and apparatus disclosed by the present disclosure are suitable for calibrating an internal error value of an oval scanning airborne bathymetric lidar. By calibrating a laser ranging error, a collimation axis error, and a rotation angle error of a driving motor step by step, the complexity of error calibration is reduced, the influence of multi-factor interference on the overall calibration accuracy is avoided, and the internal error value of the lidar can be effectively calibrated. This error value can be used to assess the quality of an instrument in the instrument processing and assembly stages, and correct the systematic error in the subsequent calculation, thereby avoiding the decline of accuracy caused by the error of the measurement data of the lidar itself and improving the acquisition accuracy of the laser three-dimensional point cloud data.

### BRIEF DESCRIPTION OF THE DRAWINGS

FIG. 1 is a diagram of technical process of a method according to the present disclosure;

FIG. 2 is a schematic diagram of a calibration test field;

FIGS. 3A and 3B are diagrams of a correction result of a laser ranging error;

FIG. 4 is a schematic diagram of a laser scanning reference coordinate system;

FIG. 5 is a diagram of the change of an azimuth angle with a rotation angle of a driving motor;

FIG. 6 is a schematic diagram of an apparatus according to the present disclosure.

### DETAILED DESCRIPTION OF THE EMBODIMENTS

In order to make the objectives, technical solutions and advantages of the present disclosure more clearly, the present disclosure is further described in detail below in conjunction with specific embodiments and with reference to accompanying drawings. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

An internal error of an airborne bathymetric lidar mainly includes a ranging error and a structural error, where the structural error is composed of a collimation axis error and a rotation angle error of a driving motor. The collimation axis error further includes an error of an included angle between a mirror normal and a rotating shaft of the driving motor and an error of an included angle between an incident light and the rotating shaft of the driving motor. These errors are coupled with each other and difficult to be calibrated in a unified manner. For this problem, a method and apparatus for calibrating an internal error of an oval scanning airborne bathymetric lidar step by step are provided. By calibrating each internal error step by step, the mutual interference between different error sources is reduced, and accurate calibration of the internal error value of the lidar can be achieved.

### Embodiment 1

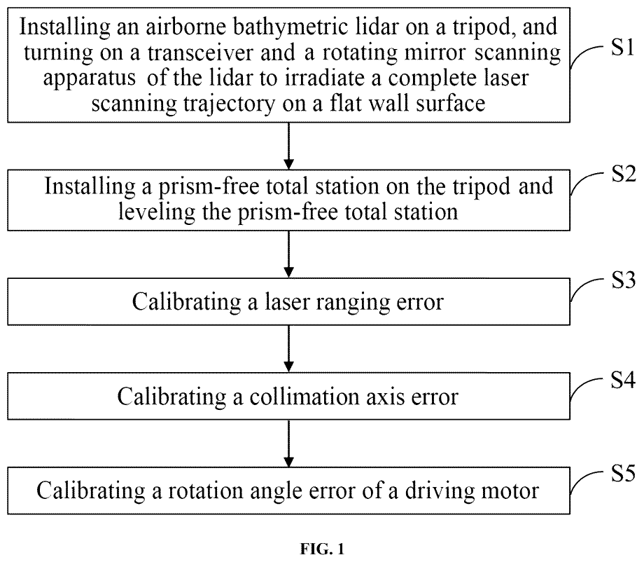

A technical process of a method for calibrating an internal error of an oval scanning airborne bathymetric lidar step by step provided by the present disclosure is described in conjunction with FIG. 1, including:
S1: installing an airborne bathymetric lidar on a tripod, and turning on a transceiver and a rotating mirror scanning apparatus of the lidar to irradiate a complete laser scanning trajectory on a flat wall surface;
S2: installing a prism-free total station on the tripod and leveling the prism-free total station;
S3: calibrating a laser ranging error;
S4: calibrating a collimation axis error; and
S5: calibrating a rotation angle error of a driving motor.

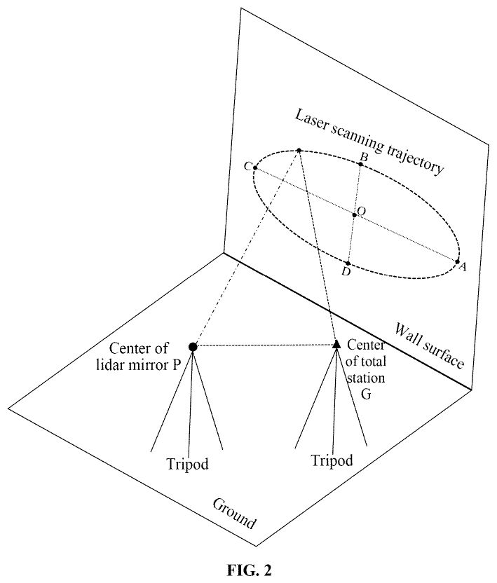

S1 is specifically as follows:
A calibration test field is described in conjunction with FIG. 2, the tripod is placed on a level ground, the airborne bathymetric lidar is installed on the tripod, and the transceiver and the rotating mirror scanning apparatus of the lidar are turned on to irradiate the complete laser scanning trajectory on the flat wall surface.

A scanning mode of the lidar is oval scanning, where the incident light and the rotating shaft of the driving motor are in a same plane and form an angle of 45°. The mirror normal is inconsistent with a direction of the rotating shaft of the driving motor. When the lidar mirror is driven by the driving motor to rotate at a high speed, the mirror normal forms a cone in a space, and a horizontally incident laser beam is reflected by the lidar mirror in different directions to form an oval laser footprint on a target plane.

S2 is specifically as follows:
the prism-free total station is installed on the tripod and levelled to ensure that the prism-free total station is intervisibility with the center of the lidar mirror and the laser footprint of the wall surface.

S3 is specifically as follows:
As shown in FIG. 2, a center point of the lidar mirror is marked as P, a center point, vertexes of a long axis and vertexes of a short axis of a laser scanning trajectory are marked as O, A, C, B and D, respectively, a scanning sequence of laser footprints is marked as A-B-C-D, and a center point of the prism-free total station is marked as G.

The transceiver and the rotating mirror scanning apparatus of the lidar are turned off, the lidar mirror is manually rotated, the transceiver is turned on every 300 to collect waveform data, and waveform detection is performed to obtain a calculated distance value, and the prism-free total station is configured to measure an observed distance value from the center of the mirror to the laser footprint of the wall surface.

For example, Table 1 shows calculated distance values and observed distance values of 12 laser footprints on the wall surface collected in this embodiment.

TABLE 1
(unit: m)

| Serial number | Calculated distance value | Observed distance value |
|---|---|---|
| 1 | 9.941 | 8.997 |
| 2 | 9.898 | 8.967 |
| 3 | 9.890 | 8.968 |
| 4 | 9.946 | 9.005 |
| 5 | 10.009 | 9.048 |
| 6 | 10.048 | 9.087 |
| 7 | 10.063 | 9.114 |
| 8 | 10.025 | 9.076 |
| 9 | 9.977 | 9.024 |
| 10 | 9.953 | 8.991 |
| 11 | 9.930 | 8.976 |
| 12 | 9.938 | 8.983 |

The calculated distance value s is enabled to be [s₁, s₂, . . . s₁₂]^{T}, and a corresponding observed distance value S′ thereof is enabled to be [S₁′, S₂′, . . . , S₁₂′]^{T}.

A calculation formula of the calculated distance value is as follows:

$$s = c Δ t / 2 ;$$

where c is a propagation speed of laser in air, and Δt is propagation time of laser in the air obtained by the waveform detection.

An error plus constant K is added into the above formula:

$$S = f ( K ) = s + K = {[ {S}_{1} , S 2 , … , {S}_{12} ]}^{T} ;$$

where an initial value of the error plus constant K is set as a negative value of a design length of an internal optical path of the lidar.

For example, the design length of the internal optical path of the lidar used in this embodiment is 1 m, so the initial value of K is −1 m, the calculated distance value in Table 1 is substituted into the above formula to calculate S, with a result shown in Table 2.

TABLE 2
(unit: m)

| Serial number | s | S |
|---|---|---|
| 1 | 9.941 | 8.941 |
| 2 | 9.898 | 8.898 |
| 3 | 9.890 | 8.890 |
| 4 | 9.946 | 8.946 |
| 5 | 10.009 | 9.009 |
| 6 | 10.048 | 9.048 |
| 7 | 10.063 | 9.063 |
| 8 | 10.025 | 9.025 |
| 9 | 9.977 | 8.977 |
| 10 | 9.953 | 8.953 |
| 11 | 9.930 | 8.930 |
| 12 | 9.938 | 8.938 |

The above formula is linearized to establish an error equation:

$$v = \frac{\partial f}{\partial K} Δ K - [ {S}^{′} - S ] = Δ K - [ {S}^{′} - S ] ;$$

the above formula is written in a matrix form:

$$V = BX - L ;$$

$$X = Δ K .$$

There are 12 laser footprints, then

$$B = [ \begin{matrix}1 & 0 & ⋯ & 0 \\ 0 & 1 & ⋯ & 0 \\ ⋮ & ⋮ & 1 & ⋮ \\ 0 & 0 & ⋯ & 1\end{matrix} ] , L = [ \begin{matrix}{L}_{1} \\ {L}_{2} \\ ⋮ \\ {L}_{i} \\ ⋮ \\ {L}_{12}\end{matrix} ] .$$

For each laser footprint,

$${L}_{i} = [ {S}_{i}^{′} - {S}_{i} ] .$$

Based on a principle of least-squares indirect adjustment, a normal equation of the error equation is listed:

$$1 {B}^{T} BX = {B}^{T} L ;$$

the above formula is solved to obtain:

$$X = {( {B}^{T} B )}^{- j} {B}^{T} L ;$$

S and S′ are substituted into the above formula to calculate a correction ΔK of K.

For example, S′ (observed distance value) and S in Table 1 and Table 2 are substituted into the above formula to calculate ΔK=0.052 m.

The error plus constant is updated according to ΔK:

$$K + Δ K \to K .$$

For example, an initial value of the error plus constant K in this embodiment is −1 m, and after updating, K is −0.948 m.

S is recalculated according to the updated error plus constant K, then L is recalculated, and then the normal equation of the error equation is solved based on the principle of least-squares indirect adjustment to obtain the correction ΔK, and an error plus constant K is updated again, the steps are repeated until |ΔK|<0.001.

For example, in this embodiment, iterative calculation is performed once, and the finally calculated error plus constant K is −0.948 m.

In consideration of an error, the calculated distance value of the lidar is as follows:

$$S = c Δ t / 2 + K .$$

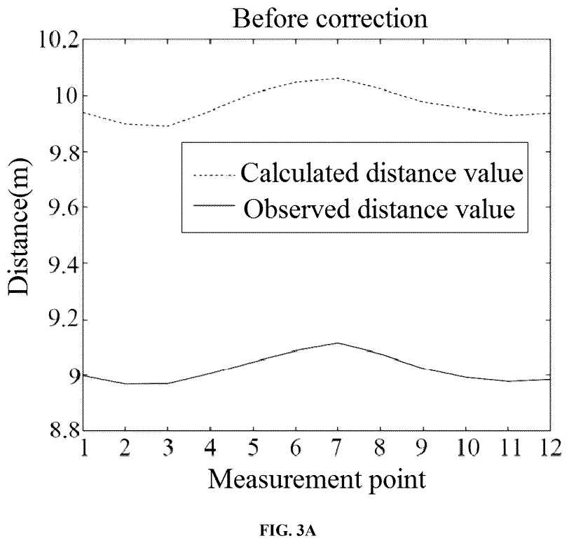

For example, a correction result of the laser ranging error is described in conjunction with FIG. 3s 3A and 3B. After ranging error correction, the calculated distance value is close to the observed distance value.

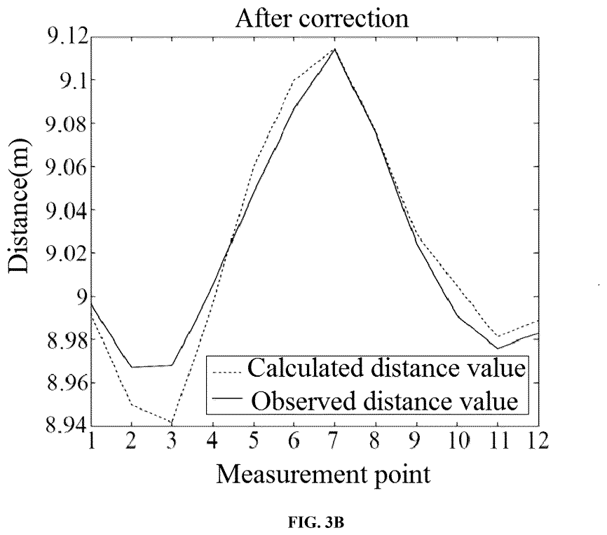

S4 is specifically as follows:
A laser scanning reference coordinate system is described in conjunction with FIG. 4. The laser scanning reference coordinate system O-XYZ is established with the center of the lidar mirror as an origin, with an X axis as an opposite direction of the incident light, a Y axis as a flight direction, and a Z axis and the X axis and Y axis forming a right-handed system; the rotation angle of the driving motor is defined as θ, the included angle between the mirror normal and the rotating shaft of the driving motor is defined as α, the included angle between incident light and the rotating shaft of the driving motor is defined as β, and a direction vector of the mirror normal in the O-XYZ coordinate system is as follows:

$$\vec{F} = [ \begin{matrix}{F}_{x} \\ {F}_{y} \\ {F}_{z}\end{matrix} ] = [ \begin{matrix}sin ( α ) cos ( β ) cos ( θ ) + cos ( α ) sin ( β ) \\ sin ( α ) sin ( θ ) \\ sin ( α ) sin ( β ) cos ( θ ) - cos ( α ) cos ( β )\end{matrix} ] ;$$

as can be seen from above formula that included angles between projections of reflected light on an XZ plane and a YZ plane and the Z axis are as follows:

$${φ}_{x} ( α , β , θ ) = 2 {tan}^{- 1} ( {F}_{x} / \vert {F}_{z} \vert ) - 90 ° ;$$

$${φ}_{y} ( α , β , θ ) = {tan}^{- 1} ( {F}_{y} / \vert {F}_{z} \vert ) .$$

An included angle between the reflected light and a vertical downward direction is defined as a scanning angle, and a scanning angle φ is calculated according to the above formula:

$$φ ( α , β , θ ) = {tan}^{- 1} ( \sqrt{{( tan {φ}_{x} )}^{2} + {( tan {φ}_{y} )}^{2}} ) .$$

An included angle between a connecting line of the laser footprint and a center point of the laser scanning trajectory and a positive direction of the X axis is defined as an azimuth angle, when the connecting line of the center of the laser scanning trajectory and the center of the lidar mirror is perpendicular to a target plane, the azimuth angle Ψ is calculated according to the included angles between the projections of reflected light on the XZ and YZ planes and the Z axis:

$$Ψ ( α , 45 ° , θ ) = \{ \begin{matrix}{tan}^{- 1} ( tan {φ}_{y} / tan {φ}_{x} ) , 0 ° \leq θ < 90 ° \\ {tan}^{- 1} ( tan {φ}_{y} / tan {φ}_{x} ) + 90 ° , 90 ° \leq θ < 270 ° \\ {tan}^{- 1} ( tan {φ}_{y} / tan {φ}_{x} ) + 180 ° , 270 ° \leq θ < 360 °\end{matrix} . \qquad ( 1 )$$

Coordinates of the laser footprint in the laser scanning reference coordinate system are calculated according to the calculated distance value S of the lidar, the projections φₓ and φ_{y} of the reflected light on the XZ and the YZ planes and the scanning angle φ:

$$[ \begin{matrix}x ( α , β , θ ) \\ y ( α , β , θ ) \\ z ( α , β , θ )\end{matrix} ] = [ \begin{matrix}S * cos φ * tan {φ}_{x} \\ S * cos φ * tan {φ}_{y} \\ - S * cos φ\end{matrix} ] .$$

The transceiver and the rotating mirror scanning apparatus of the lidar are turned off, and the lidar mirror is manually rotated to enable laser footprints to fall to points A, B, C and D in turn, the transceiver is turned on to collect waveform data, the laser ranging error is eliminated after waveform detection to obtain calculated distance values S_{A}, S_{B}, S_{C} and S_{D} in turn, and the calculated distance values as well as rotation angles of the driving motor which are 0°, 90°, 180° and 270° are substituted into the above formula in turn to obtain coordinates of the points A, B, C and D in the laser scanning reference coordinate system as follows: [x_{A}(α, β, 0°), y_{A}(α, β, 0°), z_{A}(α, β, 0°)]^{T}, [x_{B}(α, β, 90°), y_{B}(α, β, 90°), z_{B}(α, β, 90°)]^{T}, [x_{C}(α, β, 180°), y_{C}(α, β, 180°), z_{C}(α, β, 180°)]^{T}, and [x_{D}(α, β, 270°), y_{D}(α, β, 270°), z_{D}(α, β, 270°)]^{T}.

A formula for calculating a distance between two points according to the coordinates of two points is as follows:

$$H ( α , β ) = \sqrt{{( {x}_{1} - {x}_{2} )}^{2} + {( {y}_{1} - {y}_{2} )}^{2} + {( {z}_{1} - {z}_{2} )}^{2}} ;$$

where initial values of α and β are respectively set as a designed included angle between the mirror normal and the rotating shaft of the driving motor and a designed included angle between the incident light and the rotating shaft of the driving motor.

The coordinates of points A and B, points A and C, points A and D, points B and C, points B and D, and points C and D are substituted into the above formula in turn to obtain an AB distance H_{AB}, an AC distance H_{A}C, an AD distance H_{AD}, a BC distance H_{BC}, a BD distance H_{B}D and a CD distance H_{CD}, respectively.

The prism-free total station is configured to measure an AB distance H′_{AB}, an AC distance H′_{AC}, an AD distance H′_{AD}, a BC distance H′_{BC}, a BD distance H′_{BD}, and a CD distance H′_{CD}.

H is enabled to be {H_{AB}, H_{AC}, H_{AD}, H_{BC}, H_{BD}, H_{CD}}, H′ is enabled to be {H′_{AB}, H′_{AC}, H′_{AD}, H′_{BC}, H′_{BD}, H′_{CD}}.

For example, in this embodiment, the included angle between the mirror normal and the rotating shaft of the driving motor is designed as 5°, and the included angle between the incident light and the rotating shaft of the driving motor is designed as 45°, so the initial values of α and β are set as 5° and 45°, respectively. The coordinates of the points A, B, C and D in the laser scanning reference coordinate system are as shown in Table 3, and the coordinates in Table 3 are substituted into the distance calculation formula to calculate H, with a result shown in Table 4.

TABLE 3
(unit: m)

| Point number | x | y | z |
|---|---|---|---|
| A | 1.745 | 0 | −9.897 |
| B | 0 | 1.220 | −9.859 |
| C | −1.739 | 0 | −9.864 |
| D | 0 | −1.227 | −9.913 |

TABLE 4
(unit: m)

| Serial number | H | H′ |
|---|---|---|
| 1 | 2.129 | 1.703 |
| 2 | 3.485 | 2.809 |
| 3 | 2.133 | 1.853 |
| 4 | 2.124 | 1.605 |
| 5 | 2.447 | 1.964 |
| 6 | 2.129 | 1.699 |

The distance calculation formula is linearized to establish an error equation:

$$v = [ \frac{\partial H}{\partial α} Δα + \frac{\partial H}{\partial β} Δ β ] - [ {H}^{′} - H ] .$$

The above formula is written in a matrix form:

$$V = B X - L ;$$

$$where X = {[ Δ α Δ β ]}^{T} .$$

There are 6 laser footprints, then

$$B = [ \begin{matrix}{B}_{1} & 0 & ⋯ & 0 \\ 0 & {B}_{2} & ⋯ & 0 \\ ⋮ & ⋮ & {B}_{i} & ⋮ \\ 0 & 0 & ⋯ & {B}_{6}\end{matrix} ] , L = [ \begin{matrix}{L}_{1} \\ {L}_{2} \\ ⋮ \\ {L}_{i} \\ ⋮ \\ {L}_{6}\end{matrix} ] .$$

For each laser footprint,

$${B}_{i} = [ \frac{\partial {H}_{i}}{\partial α} \frac{\partial {H}_{i}}{\partial β} ] , {L}_{i} = [ {H}_{i}^{′} - {H}_{i} ] .$$

Based on the principle of least-squares indirect adjustment, a normal equation of the error equation is listed:

$${B}^{T} BX = {B}^{T} L .$$

The above formula is solved to obtain:

$$X = {( {B}^{T} B )}^{- 1} {B}^{T} L .$$

H and H′ are substituted into the above formula to calculate corrections Δα and Δβ of α and β.

For example, H and H′ in Table 4 are substituted into the above formula to calculate Δα=−0.978°, and Δβ=−0.208°.

According to Δα and Δβ, the included angle between the mirror normal and the rotating shaft of the driving motor and the included angle between the incident light and the rotating shaft of the driving motor are updated:

$$α + Δ α \to α ;$$

$$β + Δβ \to β .$$

For example, in this embodiment, the included angle α between the mirror normal and the rotating shaft of the driving motor and the included angle β between the incident light and the rotating shaft of the driving motor are designed to be 5° and 45°, respectively, and after update, α=4.022° and β=44.792°.

H is recalculated according to the updated included angle α between the mirror normal and the rotating shaft of the driving motor and the updated included angle β between the incident light and the rotating shaft of the driving motor after update, then B and L are recalculated, and then the normal equation of the error equation is solved based on the principle of least-squares indirect adjustment to obtain the corrections Δα and Δβ for updating α and β again, the steps are repeated until |Δα|<0.001 and |Δβ|<0.001.

For example, in this embodiment, iterative calculation is performed twice, and the included angle α between the mirror normal and the rotating shaft of the driving motor is 4.024°, and the included angle β between the incident light and the rotating shaft of the driving motor is 44.743°.

An error value of the included angle between the mirror normal and the rotating shaft of the driving motor is calculated according to a designed value and a measured value:

$$Δ α = α - 5 ° ;$$

where α is a finally calculated included angle between the mirror normal and the rotating shaft of the driving motor.

For example, the error value of the included angle between the mirror normal and the rotating shaft of the driving motor calculated in this embodiment is −0.976°.

An error value of the included angle between the incident light and the rotating shaft of the driving motor is calculated according to a designed value and a measured value:

$$Δ β = β - 45 ° ;$$

where β is a finally calculated included angle between the incident light and the rotating shaft of the driving motor.

For example, the error value of the included angle between the incident light and the rotating shaft of the driving motor calculated in this embodiment is −0.266°.

S5 is specifically as follows:

The rotation angle error of the driving motor generally consists of two parts: a zero-setting error and an angular measurement error. Because the rotation angle of the driving motor of the lidar is usually measured by an angle encoder, the angular measurement accuracy is high. Therefore, the angular measurement error can be ignored, and only zero-setting error is considered in this embodiment.

To calculate the rotation angle of the driving motor from the azimuth angle by backstepping, a position of the lidar is adjusted to make a PA distance equal a PC distance and a PB distance equal a PD distance, so that a connecting line OP of the center of the laser scanning trajectory and the center of the lidar mirror is perpendicular to the wall surface, and then the rotation angle error of the driving motor is calibrated. The step of calibrating the rotation angle error of the driving motor is as follows:

The rotating mirror scanning apparatus of the lidar is turned off, the transceiver is turn on, and in this case, the driving motor is at a zero position, and reflected laser is marked as E at the laser footprint on the wall surface, and an included angle ∠AOE between OA and OE is measured by the prism-free total station. When point E is counterclockwise direction at point A, an azimuth angle is Ψ=∠AOE, and when the point E is clockwise at the point A, the azimuth angle is Ψ=360°−∠AOE.

For example, in this embodiment, it is acquired that ∠AOE is 2.085°, and when the point E is at clockwise of the point A, the azimuth angle Ψ is 357.915°.

According to a calculation formula of the azimuth angle, the included angle α between the mirror normal and the rotating shaft of the driving motor is known, and the calculation formula of the azimuth angle is expressed as:

Ψ=P(θ), wherein P(θ) is obtained by substituting the calculated parameter αinto formula (1).

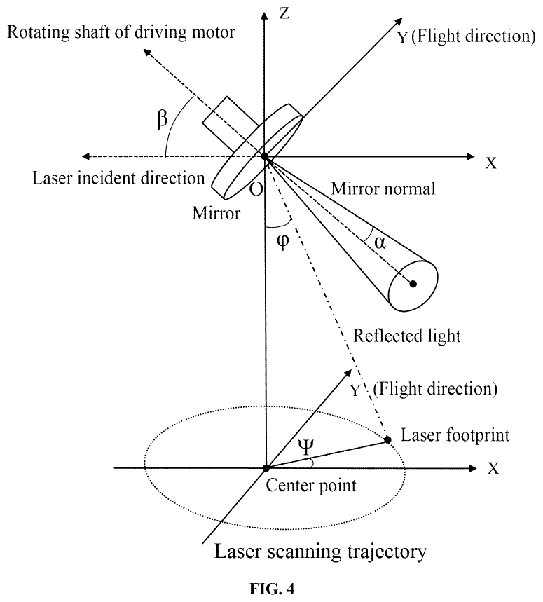

The change of the azimuth angle with the rotation angle of the driving motor is described in conjunction with FIG. 5, the azimuth angle has a positive correlation function with the rotation angle of the driving motor, and a definition domain corresponds to a value domain one by one. The measured azimuth angle Ψ is substituted into the above formula to obtain an actual rotation angle θ of the driving motor when the laser footprint falls to the point E. When the point E is counterclockwise at the point A, an error value of the rotation angle of the driving motor is Δθ=θ, when the point E is clockwise at the point A, the error value of the rotation angle of the driving motor is Δθ=θ−360°.

For example, the included angle α=4.024° between the mirror normal and the rotating shaft of the driving motor and the azimuth angle Ψ=357.915° are substituted into the above formula to obtain an actual rotation angle θ of the driving motor, which is 358.422°. Because the point E is clockwise at the point A, the error value Δθ of the rotation angle of the driving motor is −1.578°.

The above steps are repeated for five times to acquire five groups of error values of the rotation angle of the driving motor, and the five groups of error values are averaged to obtain an error value Δθ of the rotation angle of the driving motor:

$$Δ θ = \frac{{Σ}_{i = 1}^{5} Δ {θ}_{i}}{5} ;$$

where Δθᵢ is an error value of the rotation angle of the driving motor obtained in an i^{-th} measurement.

For example, Table 5 shows five groups of error values of the rotation angle of the driving motor collected in this embodiment, and the data in Table 5 are substituted into the above formula to obtain an error value Δθ of the rotation angle of the driving motor, which is −1.586°.

TABLE 5

| Serial number | 1 | 2 | 3 | 4 | 5 |
|---|---|---|---|---|---|
| Error value of rotation | −1.578° | −1.547° | −1.603° | −1.611° | −1.592° |
| angle of driving motor | | | | | |

In consideration of an error, the actual rotation angle of the driving motor is as follows:

$$\hat{θ} = θ + Δθ ;$$

where θ is a rotation angle of the driving motor measured by the angle encoder of the lidar, \hat{θ} is a rotation angle of the driving motor after error correction, when \hat{θ}>360°, \hat{θ}=\hat{θ}−360°, and when \hat{θ}<0°, \hat{θ}=\hat{θ}+360°.

### Embodiment 2

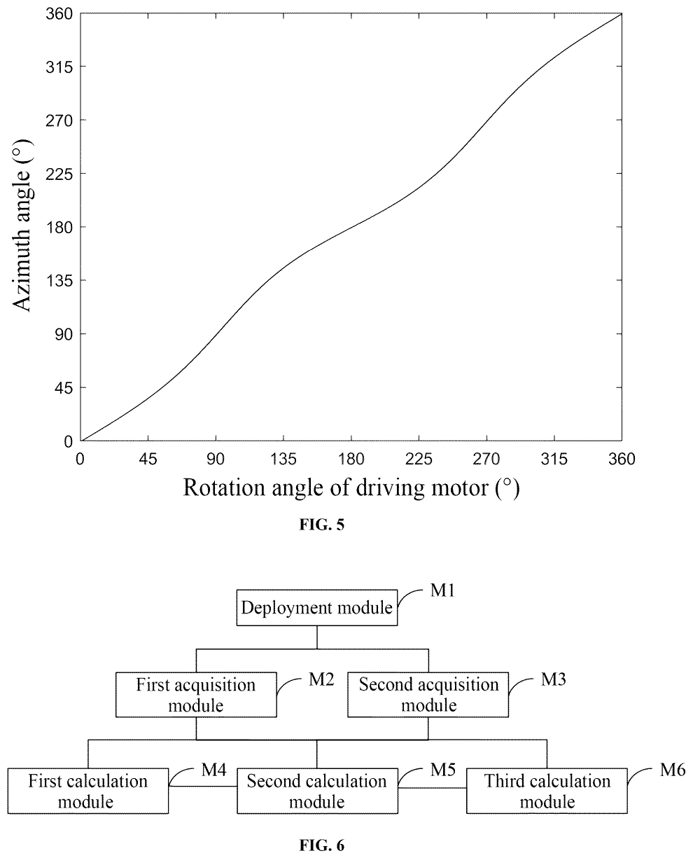

An apparatus for calibrating an internal error of an oval scanning airborne bathymetric lidar step by step provided by the present disclosure is described in conjunction with FIG. 6, the apparatus includes:
M1: a deployment module, configured to deploy an airborne bathymetric lidar and a prism-free total station in a calibration field;
M2: a first acquisition module, configured to acquire a distance calculation value of a laser footprint on a wall surface based on the lidar;
M3: a second acquisition module, configured to acquire a distance observation value between two points and included angles formed by connecting lines among three points based on the prism-free total station;
M4: a first calculation module, configured to calculate a laser ranging error;
M5: a second calculation module, configured to calculate a collimation axis error; and
M6: a third calculation module, configured to calculate a rotation angle error of a driving motor.

The specific embodiments described above further explain the objectives, technical solutions and beneficial effects of the present disclosure in detail. It should be understood that the above is merely specific embodiments of the present disclosure and are not used to limit the present disclosure. Any modification, equivalent substitution, improvement, etc. made by any skilled in the art within the technical scope the present disclosure shall be included in the scope of protection of the present disclosure.

What is claimed is:

1. A method for calibrating an internal error of an oval scanning airborne bathymetric lidar step by step, comprising:
installing an airborne bathymetric lidar on a tripod, and turning on a transceiver and a rotating mirror scanning apparatus of the lidar to irradiate a complete laser scanning trajectory on a flat wall surface;
installing a prism-free total station on the tripod and leveling the prism-free total station;
calibrating a laser ranging error;
calibrating a collimation axis error; and
calibrating a rotation angle error of a driving motor.

2. The method for calibrating the internal error of the oval scanning airborne bathymetric lidar step by step according to claim 1, wherein calibrating the laser ranging error comprises:
marking a center point of a lidar mirror as P, a center point, vertexes of a long axis and vertexes of a short axis of the laser scanning trajectory as O, A, C, B and D respectively with a scanning sequence of laser footprints as: A-B-C-D, and a center point of the prism-free total station as G;
turning off the transceiver and the rotating mirror scanning apparatus of the lidar, manually rotating the lidar mirror, turning on the transceiver every 30°, collecting waveform data and performing waveform detection to obtain a calculated distance value, and measuring an observed distance value from the center of the lidar mirror to a laser footprint of the wall surface by the prism-free total station;
enabling the calculated distance value s to be [s₁, s₂, . . . s₁₂]^{T}, and a corresponding observed distance value S′ thereof to be [S₁′, S₂′, . . . , S₁₂′]^{T};
wherein a calculation formula of the calculated distance value is as follows:
$$s = c Δ t / 2 ,$$
wherein c is a propagation speed of laser in air, and Δt is propagation time of laser in the air obtained by the waveform detection;
adding an error plus constant K to the above formula:
$$S = f ( K ) = s + K = {[ {S}_{1} , {S}_{2} , … , {S}_{12} ]}^{T} ,$$
wherein an initial value of the error plus constant K is set as a negative value of a design length of an internal optical path of the lidar;
linearizing above formula to establish an error equation:
$$v = \frac{\partial f}{\partial K} Δ K - [ {S}^{′} - S ] = Δ K - [ {S}^{′} - S ] ;$$
writing the above formula in a matrix form:
$$V = B X - L ;$$
$$wherein X = Δ K ;$$
providing a total of 12 laser footprints, then
$$B = [ \begin{matrix}1 & 0 & … & 0 \\ 0 & 1 & … & 0 \\ ⋮ & ⋮ & 1 & ⋮ \\ 0 & 0 & … & 1\end{matrix} ] , L = [ \begin{matrix}{L}_{1} \\ {L}_{2} \\ ⋮ \\ {L}_{i} \\ ⋮ \\ {L}_{12}\end{matrix} ] ;$$
for each laser footprint,
$${L}_{i} = [ {S}_{i}^{′} - {S}_{i} ] ;$$
based on a principle of least-squares indirect adjustment, listing a normal equation of the error equation:
$${B}^{T} B X = {B}^{T} L ;$$
solving the above formula to obtain:
$$X = {( {B}^{T} B )}^{- 1} {B}^{T} L ;$$
substituting S and S′ into the above formula to calculate a correction ΔK of K;
updating the error plus constant according to ΔK:
$$K + Δ K \to K ;$$
recalculating S according to an updated error plus constant K, then recalculating L, and then solving the normal equation of the error equation based on the principle of least-squares indirect adjustment to obtain the correction ΔK, and updating the error plus constant K again, repeating the steps until |ΔK|<0.001; wherein
in consideration of an error, the calculated distance value of the lidar is as follows:
$$S = c Δ t / 2 + K .$$

3. The method for calibrating the internal error of the oval scanning airborne bathymetric lidar step by step according to claim 1, wherein calibrating the collimation axis error comprises:
wherein the collimation axis error comprises an error of an included angle between a mirror normal and a rotating shaft of the driving motor and an error of an included angle between an incident light and the rotating shaft of the driving motor;
establishing a laser scanning reference coordinate system O-XYZ with a center of the lidar mirror as an origin, with an X axis as an opposite direction of the incident light, a Y axis as a flight direction, and a Z axis and the X axis and Y axis forming a right-handed system; defining the rotation angle of the driving motor as θ, the included angle between the mirror normal and the rotating shaft of the driving motor as α, the included angle between the incident light and the rotating shaft of the driving motor as β, and a direction vector of the mirror normal in the O-XYZ coordinate system as follows:
$$\vec{F} = [ \begin{matrix}{F}_{x} \\ {F}_{y} \\ {F}_{z}\end{matrix} ] = [ \begin{matrix}sin ( α ) cos ( β ) cos ( θ ) + cos ( α ) sin ( β ) \\ sin ( α ) sin ( θ ) \\ sin ( α ) sin ( β ) cos ( θ ) - cos ( α ) cos ( β )\end{matrix} ] ;$$
obtaining included angles between projections of reflected light on an XZ plane and a YZ plane and the Z axis from the above formula as follows:
$${φ}_{x} ( α , β , θ ) = 2 {tan}^{- 1} ( {F}_{x} / \vert {F}_{z} \vert ) - 90 ° ;$$
$${φ}_{y} ( α , β , θ ) = {tan}^{- 1} ( {F}_{y} / \vert {F}_{z} \vert ) ;$$
defining an included angle between the reflected light and a vertical downward direction as a scanning angle, and calculating the scanning angle φ according to the above formula:
$$φ ( α , β , θ ) = {tan}^{- 1} ( \sqrt{{( tan {φ}_{x} )}^{2} + {( tan {φ}_{y} )}^{2}} ) ;$$
defining an included angle between a connecting line of the laser footprint and a center point of the laser scanning trajectory and a positive direction of the X axis as an azimuth angle, when the connecting line of the center of the laser scanning trajectory and the center of the lidar mirror is perpendicular to a target plane, calculating the azimuth angle Ψ according to the included angles between the projections of reflected light on the XZ and YZ planes and the Z axis:
$$Ψ ( α , 45 ° , θ ) = \{ \begin{matrix}{tan}^{- 1} ( tan {φ}_{y} / tan {φ}_{x} ) , 0 ° \leq θ < 90 ° \\ {tan}^{- 1} ( tan {φ}_{y} / tan {φ}_{x} ) + 90 ° , 90 ° \leq θ \leq 270 ° \\ {tan}^{- 1} ( tan {φ}_{y} / tan {φ}_{x} ) + 180 ° , 270 ° < θ \leq 360 °\end{matrix} ; \qquad ( 1 )$$
calculating coordinates of the laser footprint in the laser scanning reference coordinate system according to the calculated distance value S of the lidar, the projections φₓ and φ_{y} of the reflected light on the XZ and the YZ planes and the scanning angle φ:
$$[ \begin{matrix}x ( α , β , θ ) \\ y ( α , β , θ ) \\ z ( α , β , θ )\end{matrix} ] = [ \begin{matrix}S * cos φ * tan {φ}_{x} \\ S * cos φ * tan {φ}_{y} \\ - S * cos φ\end{matrix} ] ;$$
turning off the transceiver and the rotating mirror scanning apparatus of the lidar, and manually rotating the lidar mirror to enable laser footprints to fall to points A, B, C and D in turn, turning on the transceiver to collect waveform data, eliminating the laser ranging error after waveform detection to obtain calculated distance values S_{A}, S_{B}, S_{C} and S_{D} in turn, and substituting the calculated distance values as well as rotation angles of the driving motor which are 0°, 90°, 180° and 270° into the above formula in turn to obtain coordinates of the points A, B, C and D in the laser scanning reference coordinate system as follows: [x_{A}(α, β, 0′), y_{A}(α, β, 0°), z_{A}(α, β, 0°)]^{T}, [x_{B}(α, β, 90°), y_{B}(α, β, 90°), z_{B}(α, β, 90°)]^{T}, [x_{C}(α, β, 180°), y_{C}(α, β, 180°), z_{C}(α, β, 180°)]^{T}, and [x_{D}(α, β, 270°), y_{D}(α, β, 270°), z_{D}(α, β, 270°)]^{T};
wherein a formula for calculating a distance between two points according to the coordinates of two points is as follows:
$$H ( α , β ) = \sqrt{{( {x}_{1} - {x}_{2} )}^{2} + {( {y}_{1} - {y}_{2} )}^{2} + {( {z}_{1} - {z}_{2} )}^{2}} ;$$
wherein the included angle between the mirror normal and the rotating shaft of the driving motor is designed as 5°, and the included angle between the incident light and the rotating shaft of the driving motor is designed as 45°, so initial values of α and β are set as 5° and 45°, respectively;
substituting the coordinates of points A and B, points A and C, points A and D, points B and C, points B and D, and points C and D into the above formula in turn to obtain an AB distance H_{AB}, an AC distance H_{AC}, an AD distance H_{AD}, a BC distance H_{BC}, a BD distance H_{BD} and a CD distance H_{CD}, respectively;
measuring an AB distance H′_{AB}, an AC distance H′_{AC}, an AD distance H′_{AD}, a BC distance H′_{BC}, a BD distance H′_{BD}, and a CD distance H′_{CD} by the prism-free total station;
$$enabling H = \{ {H}_{AB} , {H}_{A C} , {H}_{AD} , {H}_{BC} , {H}_{BD} , {H}_{CD} \} ,$$
$$and {H}^{′} = \{ {H}_{AB}^{′} , {H}_{A C}^{′} , {H}_{AD}^{′} , {H}_{BC}^{′} , {H}_{BD}^{′} , {H}_{CD}^{′} \} ;$$
linearizing a distance calculation formula to establish an error equation:
$$v = [ \frac{\partial H}{\partial α} Δα + \frac{\partial H}{\partial β} Δ β ] - [ {H}^{′} - H ] ;$$
writing the above formula in a matrix form:
$$V = B X - L ;$$
$$wherein X = {[ Δα Δβ ]}^{T} ;$$
providing a total of 6 laser footprints, then
$$B = [ \begin{matrix}{B}_{1} & 0 & … & 0 \\ 0 & {B}_{2} & … & 0 \\ ⋮ & ⋮ & {B}_{i} & ⋮ \\ 0 & 0 & … & {B}_{6}\end{matrix} ] , L = [ \begin{matrix}{L}_{1} \\ {L}_{2} \\ ⋮ \\ {L}_{i} \\ ⋮ \\ {L}_{6}\end{matrix} ] ;$$
for each laser footprint,
$${B}_{i} = [ \frac{\partial {H}_{i}}{\partial α} \frac{\partial {H}_{i}}{\partial β} ] , {L}_{i} = [ {H}_{i}^{′} - {H}_{i} ] ;$$
based on a principle of least-squares indirect adjustment, listing a normal equation of the error equation:
$${B}^{T} B X = {B}^{T} L ;$$
solving the above formula to obtain:
$$X = {( {B}^{T} B )}^{- 1} {B}^{T} L ;$$
substituting H and H′ into the above formula to calculate corrections Δα and Δβ of α and β;
updating the included angle between the mirror normal and the rotating shaft of the driving motor and the included angle between the incident light and the rotating shaft of the driving motor according to Δα and Δβ:
$$α + Δ α \to α ;$$
$$β + Δβ \to β ;$$
recalculating H according to the included angle α between the the mirror normal and the rotating shaft of the driving motor and the included angle β between the incident light and the rotating shaft of the driving motor after update, then recalculating B and L, and then solving the normal equation of the error equation based on the principle of least-squares indirect adjustment to obtain the corrections Δα and Δβ for updating α and β again, repeating the steps until |Δα|<0.001 and |Δβ|<0.001;
calculating an error value of the included angle between the mirror normal and the rotating shaft of the driving motor according to a design value and a measured value:
$$Δ α = α - 5 ° ;$$
wherein α is a finally calculated included angle between the mirror normal and the rotating shaft of the driving motor; and
calculating an error value of the included angle between the incident light and the rotating shaft of the driving motor according to a design value and a measured value:
$$Δ β = β - 45 ° ;$$
wherein β is a finally calculated included angle between the incident light and the rotating shaft of the driving motor.

4. The method for calibrating the internal error of the oval scanning airborne bathymetric lidar step by step according to claim 1, wherein calibrating the rotation angle error of the driving motor comprises:
adjusting a position of the lidar to enable a connecting line OP of the center of the laser scanning trajectory and the center of the lidar mirror to be perpendicular to the wall surface, wherein calibrating the rotation angle error of the driving motor is as follows:
turning off the rotating mirror scanning apparatus of the lidar, turning on the transceiver, wherein the driving motor is at a zero position, and marking reflected laser as E at the laser footprint on the wall surface;
measuring an included angle ∠AOE between OA and OE by the prism-free total station;
wherein when point E is counterclockwise at point A, an azimuth angle is Ψ=∠AOE, and when the point E is clockwise at the point A, the azimuth angle is Ψ=360°−∠AOE;
according to an azimuth angle calculation formula, in a case of knowing the included angle α between the mirror normal and the rotating shaft of the driving motor, expressing the azimuth angle calculation formula as follow:
Ψ=P(θ), wherein P(θ) is obtained by substituting the calculated parameter α into formula (1);
substituting the measured azimuth angle Ψ into the above formula to solve an actual rotation angle θ of the driving motor when the laser footprint falls to the point E, wherein when the point E is counterclockwise at the point A, an error value of the rotation angle of the driving motor is Δθ=θ, and when the point E is clockwise at the point A, the error value of the rotation angle of the driving motor is Δθ=θ−360°.
repeating above steps for five times to acquire five groups of error values of the rotation angle of the driving motor, and averaging the five groups of error values to obtain the error value Δθ of the rotation angle of the driving motor:
$$Δ θ = \frac{{\sum }_{i = 1}^{5} Δ {θ}_{i}}{5} ;$$
wherein Δθᵢ is an error value of the rotation angle of the driving motor obtained in an i^{-th} measurement;
wherein in consideration of an error, the actual rotation angle of the driving motor is as follows:
$$\hat{θ} = θ + Δθ ;$$
wherein θ is a rotation angle of the driving motor measured by an angle encoder of the lidar, \hat{θ} is a rotation angle of the driving motor after error correction, when \hat{θ}>360°, \hat{θ}=\hat{θ}−360°, and when \hat{θ}<0°, \hat{θ}=\hat{θ}+360°.

5. An apparatus for calibrating an internal error of an oval scanning airborne bathymetric lidar step by step, comprising:
a first deployment module, configured to deploy an airborne bathymetric lidar and a prism-free total station in a calibration field;
a first acquisition module, configured to acquire a distance calculation value of a laser footprint on a wall surface based on the lidar;
a second acquisition module, configured to acquire a distance observation value between two points and included angles formed by connecting lines among three points based on the prism-free total station;
a first calculation module, configured to calculate a laser ranging error;
a second calculation module, configured to calculate a collimation axis error; and
a third calculation module, configured to calculate a rotation angle error of a driving motor.
